(19) United States
(12) Patent Application Publication
(10) Pub. No.: US 2008/0078829 A1
(43) Pub. Date: Apr. 3, 2008

(54) Inventory manager service and assistant for PCB manufacturing

(75) Inventor: Chris Woodward, Atlanta, GA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Energy & Automation, Inc, Alpharetta, GA (US)

(21) Appl. No.: 11/905,220

(22) Filed: Sep. 28, 2007

Related U.S. Application Data
(60) Provisional application No. 60/827,600, filed on Sep. 29, 2006.
(60) Provisional application No. 60/827,745, filed on Oct. 2, 2006.
(60) Provisional application No. 60/862,104, filed on Oct. 19, 2006.

(51) Int. Cl. G06F 7/00

(52) U.S. Cl. 235/376

(57) ABSTRACT

A method of monitoring, in real time, process data of a printed circuit board assembly line includes monitoring status or data from machines (11) in the assembly line. Based on the monitoring step, an order of events to be performed on the assembly line is determined. The determined order identifies a priority event. A user is notified of at least the priority event via at least one hand held device (12) carried by the user. The priority event is then attended to on the assembly line.

This application claims the benefit of the earlier filing date of U.S. Provisional Application No.60/827,600, filed on Sep. 29, 2006, of U.S. Provisional Application No. 60/827,745, filed on Oct. 2, 2006, and U.S. Provisional Application No. 60/862,104, filed on Oct. 19, 2006, the content of each application is hereby incorporated by reference into this specification.

### FIELD OF THE INVENTION

The invention relates inventory management software and devices that monitor all aspects of surface mount technology (SMT) placement machines in real time.

### BACKGROUND OF THE INVENTION

When using SMT placement machines, there is a need to know where tables, feeders, or components are located and a need to identify machines that need attention (e.g., supply of components placed by the machine needing refill).

There is also a need for real time syncing of multiple consoles and handhelds to allow for multiple users to work on the same setup at the same time allowing for greater efficiency.

### SUMMARY OF THE INVENTION

An object of the invention is to fulfill the need referred to above. In accordance with the principles of the present invention, this objective is obtained by a method of monitoring, in real time, process data of a printed circuit board assembly line includes monitoring status or data from machines in the assembly line. Based on the monitoring step, an order of events to be performed on the assembly line is determined. The determined order identifies a priority event. A user is notified of at least the priority event via at least one hand held device carried by the user. The priority event is then attended to on the assembly line.

In accordance with another aspect of the invention, a system is provided for monitoring, in real time, process data of machines of a printed circuit board assembly line. The system includes a server having a processor configured for executing a monitoring process for monitoring one of status or data from machines in the assembly line, and based on the monitoring step, for determining an order of events to be performed on the assembly line, with the determined order identifying a priority event. A hand held device is in communication with the server. The hand held device is constructed and arranged to be carried by a user at the assembly line. The hand held device has a display configured for displaying at least the priority event to the user.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a schematic view of a system for monitoring, in real time, component placement machines of an electronics component assembly line in accordance with an embodiment of the invention.

FIG. 2 is a view of a hand held SIM Assistant in accordance with an embodiment of the invention.

### DETAILED DESCRIPTION OF THE EXEMPLARY EMBODIMENTS

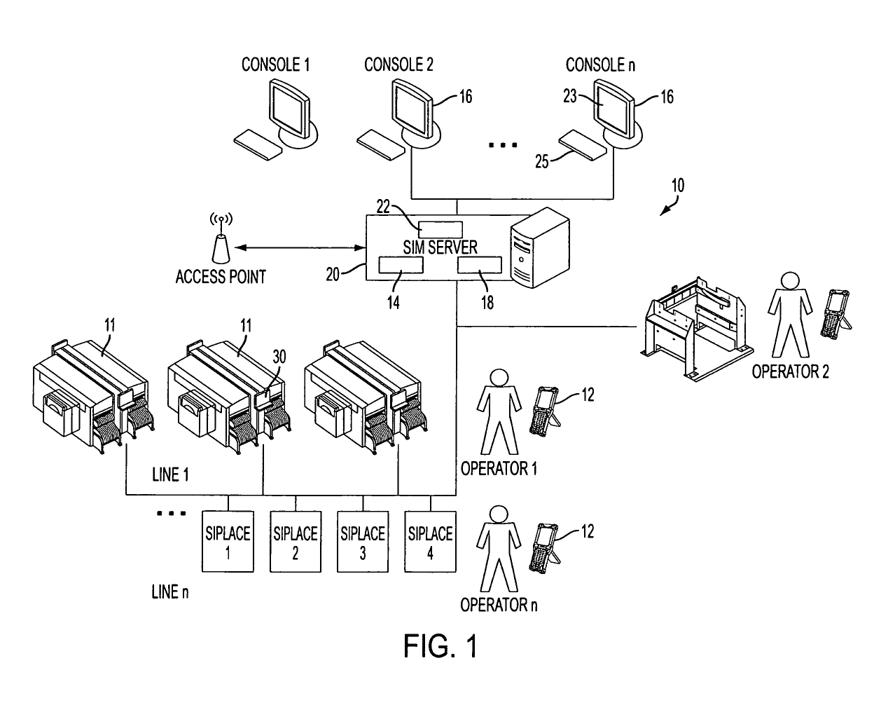

In accordance with an embodiment of the invention and with reference to FIG. 1, SIPLACE Inventory Manager (SIM) system, shown generally indicated at 10, is provided to control inventory of tables, component packaging, and feeders of SMT placement machines 11, on an assembly line such as a SIPLACE line and arbitrary warehouse locations. The system 10 includes the following functional modules: SIPLACE Inventory Manager Assistant (SIM Assistant) 12, SIPLACE Inventory Manager Service (SIM Service) 14, and at least one SIPLACE Inventory Manager Console (SIM Console) 16. The system 10 uses a database 18 on server 20 (e.g., Microsoft SQL Server) to store customer data.

The system 10 includes a software package configured to preferably work directly with SIPLACE Pro, a software package from Siemens. Thus, the modules of the system 10 can be implemented as executable code stored on a computer readable media (e.g., a hard disk drive, a floppy drive, a random access memory, a read only memory, an EPROM, a compact disc, etc.) For example, the SIM Service 14 is provided on the server 20 having a processor 22 for executing the code. The system 10 preferably uses SIPLACE Pro as the single source for line and component data. The system 10 can manage the same number of lines as defined in SIPLACE Pro. It is not possible to configure a single SIM installation to work with multiple SIPLACE Pro installations. The relationship between a SIPLACE Pro installation and a SIM system 10 installation is one to one.

The system 10 preferably uses SIPLACE History for all historical data. SIPLACE History is responsible for proving the current setup and line configuration corresponding to the most recent download for a line. SIPLACE History also provides setup data for a specific setup or recipe as required for off-line setup verification.

### The SIM Assistant 12

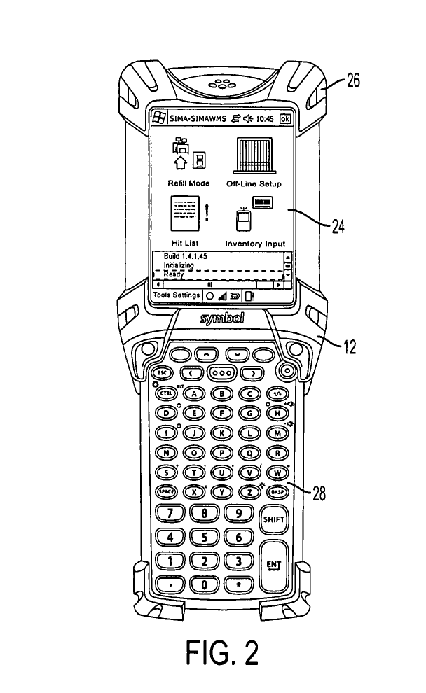

As shown in FIG. 2, the SIM Assistant 12 is a portable hand-held PDA with a touch screen display 24, a scanner 26, and a keyboard 28. The SIM Assistant 12 includes executable code stored on a computer readable media of the type disclosed above. The server 20 executing SIM Service 14 preferably communicates with the SIM Assistant 12 in a wireless manner. The primary purpose of the SIM Assistant 12 is to aid the operator to perform off-line and on-line setup verification, and to keep the operator apprised of on-line table inventory, which is constantly consumed by the placement machine, that is currently low. At production time, the user can view the priority of dwindling component supplies before a machine runs out. A single installation of SIM Service 14 supports multiple SIM Assistants 12 in the same enterprise. The SIM Assistant 12 may be user configured to support only a subset of all possible lines available in SIPLACE Pro.

### Configuration of SIM Assistant 12

The following configuration parameters are employed for the SIM Assistant 12 to operate:
Server URL—The URL to a folder, which is hosting the SIM Assistant installation. This URL is used for the initial SIM Assistant installation and subsequent automatic software updates.
Data Source—The name of the SQL database instance where SIPLACE Inventory Manager data is stored.
SQL Login—The user name that is used to access SQL data.
SQL Password—The password that is used to access SQL data
Queue Message Timeout—This parameter defines the lifetime of Message Queue messages.

### User Interface of SIM Assistant 12

Overview
The SIM Assistant user interface contains a single active window at any one time.
The notification window may be displayed or hidden at any time. The notification window informs the user of errors or activity that has recently occurred.

### Main Window

The main window is the first form visible to the user and is the surface onto which all active windows are placed.

Tools Menu

The tools menu contains the following menu items:
Hit List—allows the user to view the current hit list.
Off-line Setup—allows the user to perform off-line setup verification.
Select Line—allows the user to go to the production line view (on-line refill and setup).
Inventory Input—allows the user to input component packaging items.
Packaging Search—allows the user to search table for expected allocation of particular part numbers.
Exit—closes the SIM Assistant application.

Settings Menu

The settings menu contains the following menu items:
Options—opens the SIM Assistant options.
Display Events—selects whether the notification windows is visible or hidden.
Subscribe to Line—allows the user to choose which lines from SIPLACE Pro are active on this SIM Assistant

### Line View

The line view is used to perform on-line setup verification, to perform off-line setup verification, and to display the production line view for refilling. The line view opens with the following attributes which determine its behavior:
Selected Line—The SIPLACE Pro line with which the user is working.
Task Type—Current task of the operator, i.e. off-line or on-line setup verification.
Refill Mode—This determines if reels are spliced or replaced.
Scan Mode—This is track driven for on-line setup verification. For off-line setup verification, the user may choose component driven or track driven.

The line view window displays the following:
A graphical view of the line which includes each station in the line.
The table for each station in the line is color coded according to the state of the feeders on that table.
For a WPC or an MTC, a single level is displayed. The user may select which level is visible by the context menu or by scanning a level barcode. The divisions in the level are color coded according to the state of the components in that tray.
Individual feeders for the selected table are displayed and color coded according to their state.
Text which indicates the selected track and the component which is expected at that location.
A “More” button which is used to display the workflow status screen.
Text which indicates the task type, refill mode, and scan mode.

Within the line view, the user can either use the scanner 22 or the graphic display to arbitrarily select a station location, table, or track within the line.

The line view form executes a workflow, which uses the task settings for the task type combined with the appropriate packaging workflow. The packaging workflow is determined by the component. If the component does not have a selected workflow, the default packaging workflow is used.

The software guides the user as defined by the task type and workflow through the line. The line view visually displays the position in the line and table for the user to recognize where they are supposed to be. The workflow continues advancing automatically unless the user overrides the default flow by scanning or graphically selecting another station location, table, or track than the software has targeted.

From the line view, the user may use the selected workflow to place changeover tables at a station location and to place component packaging on a changeover table. The user may also choose to remove a changeover table, feeder, or component packaging by invoking the context menu for the respective item.

The line view form is refreshed if an update to the table is detected. Table updates may occur from the station interface, another SIM Assistant, or from the SIPLACE Inventory Manager Console (described below).

### Inventory Input

An inventory input form is used to create new component packaging item in the system inventory. The inventory input form implements a workflow using the task settings determined by the inventory input task type.

The inventory input form displays the following:
A drop down box from which the user may select the packaging workflow to use
A workflow status screen

### Hit List

A hit list form is used to display the next 10 feeder divisions which are expected to require component refill. From the hit list form the user can view which tracks will soon require attention and can directly invoke a production line view in refill mode for a selected track.

The hit list form contains the following elements:
A graphical view of the line for the track selected

A list view which includes the following attributes:

| Column Heading | Description |
|---|---|
| Station Name | Name of the station |
| Location | Table location such as 1, 2, 3 or 4 |
| | Track/Div or Tower/Level |
| Boards | Number of boards which can be created before the |
| | component count reaches zero. |

The hit list form supports the following actions:

| Event | Response |
|---|---|
| Track Selected | A graphical view of the line for the selected |
| | track appears. Tables containing divisions |
| | which will soon require attention appear in |
| | red. Tables having no tracks in use appear |
| | white. All other tables appear green. |
| Right-Click Selected Track | Context menu item “Go to Track” appears |
| Click Menu Item “Go to | The Production Line View form appears with |
| Track” | the track selected in the hit list form as the |
| | selected track. |

### Select Recipe/Setup

The select recipe/setup form is used to select the recipe or setup for off-line setup verification. This form appears when the user selects “Tools→Off-line Setup” or selects the off-line setup icon from the main form.

The select recipe/setup form contains the following elements:

| Control | | |
|---|---|---|
| Type | Text | Description |
| Tree | | This tree view contains two root |
| View | | notes, “My Recipes” and “My |
| | | Setups”. All recipes available in |
| | | SIPLACE Pro will appear beneath the |
| | | “My Recipes” node and all setups will |
| | | appear beneath “My Setups”. |
| Button | “Verify Track Based” | Opens a line view using the selected |
| | | recipe or setup. The line view form |
| | | will use task settings for off-line setup |
| | | verification and operate in track- |
| | | driven mode. |
| Button | “Verify Component | Opens a line view using the selected |
| | Based” | recipe or setup. The line view form |
| | | will use task settings for off-line setup |
| | | and operate in component-driven |
| | | mode. |

### Select Line Form

The select line form is used to re-enter the most recently downloaded setup for a selected line.

The select line form contains the following elements:

| Control | | |
|---|---|---|
| Type | Text | Description |
| Tree View | | This tree contains “My Lines” as the |
| | | root node. All lines defined in |
| | | SIPLACE Pro appear beneath this |
| | | root node. |
| Button | View | Opens the selected line in a |
| | | production line view form. |

### Subscribe To Line

The subscribe-to-line form is used to identify the lines on which a SIM Assistant 12 is expected to operate. SIM Assistants 12 are expected to receive download event notifications and to search for packaging on lines to which it subscribes.

The subscribe-to-line form contains the following elements:

| Control | | |
|---|---|---|
| Type | Text | Description |
| Tree View | | This tree contains “My Lines” as the |
| | | root node. All lines defined in |
| | | SIPLACE Pro appear beneath this |
| | | root node. Lines to which this SIM |
| | | Assistant is a subscriber appear with |
| | | a green icon. All others appear with |
| | | a red icon. |
| Button | Save | Saves the changes. |

### Packaging Search

The packaging search form is used to find track/divisions or tower/levels which contain a particular part. The packaging search form will only search for components within a particular line if the packaging search form is opened from a line view. The packaging search form searches all lines to which the SIM Assistant 12 is subscribed if it is opened from the main window.

The packaging search form contains the following elements:

| Control | | |
|---|---|---|
| Type | Text | Description |
| Text Box | | Contains the component barcode the |
| | | user is searching for. This |
| | | component barcode may be entered |
| | | manually or scanned using the |
| | | barcode scanner. |
| Button | Search | Searches the line for the part |
| | | specified. |
| List View | | Contains a row for each location |
| | | where the part is found. Each row |
| | | contains the line, station, location and |
| | | track/div or tower/level where the part |
| | | is located. |

The packaging search form supports the following events:

| Event | Response |
|---|---|
| Right-Click Selected Track | Context menu item “Go to Track” appears. |
| Click Menu Item “Go to | The production line view appears with the |
| Track” | track selected in the hit list form as the |
| | selected track. |

### Barcode Test

The barcode test form is used in combination with the SIPLACE Inventory Manager Console 16 to determine if a printed barcode conforms to a barcode format. The SIM Assistant 12 device remains in this mode sending scanned barcode information directly back to the SIM Console 16 where, presumable, the same user is configuring barcode formats and wishes to test them.

The barcode test form will contain the following UI elements

| Control | | |
|---|---|---|
| Type | Text | Description |
| Text Box | | The user enters the barcode using |
| | | the keyboard or the barcode scanner. |
| Button | Test | Submits the barcode to the SIPLACE |
| | | Inventory Manager Console 16 which |
| | | evaluates if the barcode is |
| | | satisfactory and reports the results to |
| | | the user. |

### Workflow

Workflow forms are executed within the context of an inventory input or line view form. In general, workflow forms implement the task types specified by the combination of the selected task type and the selected packaging workflow.

The selected task type determines the task item that the workflow will begin. The following displays task types and their starting task item.

| Task Type | Starting Task Item |
|---|---|
| Online Setup | Identify changeover table if changeover tables |
| Verification | are used. Otherwise, identify component. |
| Offline Setup | Identify changeover table. |
| Verification | |
| Inventory Input | Identify component. |

The following lists the general sequence of processing task items within a workflow when the user is directed by the software:
1. Identify station (can be overridden by location barcode or user selection).
2. Identify station location (can be overridden by location barcode, user selection, track barcode, tower barcode, or level barcode).
3. Identify changeover table (can be overridden by table asset tag).
4. Identify track or tower level (can be overridden by user selection, track barcode, level barcode, or tower barcode).
5. Identify component (can be overridden by part number barcode or packaging identifier).
6. Identify component attributes.

At any point in the workflow, the user may reset the current position by scanning an item or selecting a graphic element higher in the above sequence. For example, if the user has just scanned a track barcode, the software waits for component identification next. If the user suddenly changes their mind, they can scan any other track barcode and the workflow will switch to that track. This redirection is possible with any task item in the workflow.

If the current task item is identify component, the user may scan component attributes ahead of scanning the barcodes required to identify the component. This allows the user to scan barcodes found on the packaging unit in any order.

A workflow will begin with the start task item, prompt the user for barcodes defined for that task type and move forward through task items until all task items have been completed. A task item is considered to have been completed if all of the barcodes for that task item have been scanned or otherwise defined correctly.

The workflow form returns to the starting task item once all task items in the workflow have been completed or if the station location is changed. See tasks below for how workflow forms apply to each task type.

### Task Types

### On-Line Setup Verification

On-line setup verification uses a line view, which executes a workflow with a start task type of identifying a changeover table (if changeover tables are used) or identifying a component.

On-line setup verification is invoked when the user clicks “Verify” on the notification window which appears when a new setup has been downloaded to a line.

### Off-Line Setup Verification

Off-line setup verification uses a line view that executes a workflow with a start task type of identifying a changeover table. Off-line setup verification may be component driven or track driven.

### Track Driven

The user is expected to choose the correct track first and then choose the correct part for that track. The user may choose the correct track by selecting the track barcode, by touching the track on the PDA screen, or by allowing the workflow to automatically advance to the next track which requires attention.

### Component Driven

The user may scan any component packaging that is required for the current setup. The workflow form will automatically select the track where the part is to be placed.

### Inventory Input

Inventory input executes a workflow with a start task type of identify component. The packaging workflow used is determined by the drop down list on the form.

### Production Line View (Refill Mode)

Production line view is the same as online setup verification except that any reels placed on feeders are treated as splices instead of replacements. Trays in the WPC or MTC are replaced.

### The SIM Console 16

The SIM Console 16 is preferably remote from the servers 20 and in communication therewith. The console 16 includes at least a keyboard and a display so as to provide a visual live view of all inventory items in the factory via the SIM data analyzed at the server 20. The SIM console 16 refreshes itself as changes are made using the SIM Assistant 12. From the SIM Console 16, it is possible to see where component packaging items, tables, and feeders are currently allocated. The user can view all individual inventory items within the enterprise. The SIM Console is used to define workflows for component part numbers, inventory item barcodes, and inventory barcode labels. The visual system allows the user to easily select and view the information they are looking for. Alarming issues such as low component inventory on a feeder or needed refills are easy for the user to spot with the visual functions.

The SIM Console 16 has the following configuration options.
Data Source—The name of the SQL database instance where SIPLACE Inventory Manager data is stored.
SQL Login—The user name that is used to access SQL data.
SQL Password—The password that is used to access SQL data
Queue Message Timeout—This parameter defines the lifetime of Message Queue messages.

The SIM Console 16 is a single document interface application. The workspace of the application is arranged into three areas: tree control manager, editor workspace, and notification window. The tree control manager contains one tree for each of the SIM objects. The editor workspace contains an object editor appropriate for the object selected in the tree view. The notification window will display recent activity and errors.

### Tree Control Manager

The tree control manager contains the following tree controls:
My Tasks
My Barcodes
My Barcode Labels
My Lines
My Tables
My Feeders
My Lines
My Packaging

The root item for each tree control is the name of the tree control (i.e. “My Barcodes”). Except for the “My Tasks” tree and “My Barcodes” tree, the objects for each tree appear beneath the root node optionally grouped into folders. See next section for description of “My Tasks”.

Each tree includes a context menu which contains the following menu items: Add Folder, Add <object>, Rename, and Delete. The Add menu item for “My Tables” and “My Feeders” will lead to an additional menu item list requiring the user to specify the table type or feeder type.

### My Tasks

The tasks tree control includes “My Tasks” as the root node. Two nodes, “Task Settings” and “Packaging Workflows” appear beneath the root nodes. The task settings node includes the three fixed task types: setup verification, inventory input, and off-line setup verification. Workflows, which may be component specific, appear below the packaging workflows node.

### MV Barcodes

The barcodes tree control includes “My Barcodes” as the root node. Two nodes, “System” and “User” appear beneath the root node. Barcodes which apply to component packaging appear beneath the “User” node. Barcodes, which are provided by Siemens such as default station, track, and changeover table barcodes, appear beneath “System”.

### Object Editors

Each object editor allows the user to view or edit the attributes of the object.

On-Line Setup Verification Task Setting Editor

| Object Attribute | Control Type | Description |
|---|---|---|
| Verification Type | Drop List | Forced or Unforced |
| Station Location Barcode | Drop List | |
| Changeover Table | Drop List | |
| Barcode | | |
| Track Barcode | Drop List | |
| Tower/Level Barcode | Drop List | |

Inventory Input Task Setting Editor

| Object Attribute | Control Type | Description |
|---|---|---|
| System Generated | Checkbox | |
| Packaging ID | | |

Off-Line Setup Verification Task Setting Editor

| Object Attribute | Control Type | Description |
|---|---|---|
| Changeover Table | Drop List | |
| Barcode | | |
| Track Barcode | Drop List | |
| Tower/Level Barcode | Drop List | |

Packaging Workflows Editor

| Object Attribute | Control Type | Description |
|---|---|---|
| Default Workflow | Checkbox | |
| Part Number | Group Box | |
| Identification | | |
| Available part number | Drop List | Within Part Number |
| barcodes | | group box |
| Selected part number | List Box | Within Part Number |
| barcodes | | group box |
| Add | Button | Within Part Number |
| | | group box |
| Packaging Attributes | Group Box | |
| Available packing | Drop List | Within Packaging |
| attribute barcodes | | Attributes group box |
| Selected packaging | List Box | Within Packaging |
| attribute barcodes | | Attributes group box |
| Applies to Parts | Tree Control | SIPLACE Pro parts to |
| | | which this Packaging |
| | | Workflow applies |

### Barcode Editor

The barcode editor allows the user to specify barcode attributes and how a barcode will be used by the SIM Assistant 12.

It must be possible to enter all user barcodes without using regular expressions.

The barcode editor allows the user to
Create one or more fragments for a barcode.
Assign each fragment to an attribute of an inventory item.
Specify the minimum and maximum length for a barcode fragment.
Specify the characters or character types (numeric, alphanumeric, etc.) that are accepted in each field of a barcode segment.

Accept test barcodes from the SIM Assistants.

Station Editor

| Object Attribute | Control Type | Description |
|---|---|---|
| Station Identifier | Textbox | |
| Machine ID | Textbox | Used for Station |
| | | Interface |
| Station Interface | Drop List | Setup Center Interface or |
| | | SMV |

Component Packaging Editor

| Object Attribute | Control Type | Description |
|---|---|---|
| Packaging Identifier | Textbox | |
| Partnumber | Textbox | Read-only |
| Quantity | Textbox | |
| Manufacturer | Textbox | |
| Manufactured date | Textbox | |
| Expiration date | Textbox | |
| Supplier | Textbox | |
| Batch ID | Textbox | |
| Serial | Textbox | |
| User barcode 1 | Textbox | |
| User barcode 2 | Textbox | |
| User barcode 3 | Textbox | |

### Barcode Label Editor

The barcode label editor will be used to define the layout of barcode labels on media. The layout attributes will include the size of each label, number of label columns and rows per page, space between each label, header and left margin size.

Packaging Editor

| Object Attribute | Control Type | Description |
|---|---|---|
| Reel Identifier | Text box | |
| Part Number | Text box | Read only |
| Quantity | Text box | |
| Manufacturer | Text box | |
| Manufactured Date | Text box | |
| Expiration Date | Text box | |
| Supplier | Text box | |
| Batch ID | Text box | |
| Serial | Text box | |
| User barcode 1 | Text box | |
| User barcode 2 | Text box | |
| User barcode 3 | Text box | |

Feeder Editor

| Object Attribute | Control Type | Description |
|---|---|---|
| Feeder Identifier | Text box | |

Changeover Table Editor

| Object Attribute | Control Type | Description |
|---|---|---|
| Changeover Table | Text box | |
| Identifier | | |

### The SIM Service 14

The SIM Service 14 monitors the status and/or data from all SMT placement machines in an SIPLACE line to determine the next most logical operation to perform so as to make the line more efficient. The determined operation is communicated to the SIM Assistant 12 on the assembly line floor such that the user of the SIM Assistant 12 becomes a resource of system 10. The following describes features of SIM Service 14:

### Component Packaging Bulk Import

The SIPLACE Inventory Manager Service polls a folder for *.XML files every 2 seconds. These XML files are expected to contain packaging data and conform to the format specified below. Each component packaging is entered into the SIPLACE Inventory Manager database.

### Configuration

XML files are expected to be placed in the folder identified by the registry entry HKLM\Software\SIEMENS SIPLACE\SIPLACE Inventory Manager\XMLImportFolder. The default folder import is c:\xmlimport.

### Process

Files processed successfully are deleted from the {xmlimport} folder and placed in {xmlimport}\XML-OK. Files which are not processed successfully are deleted from the {xmlimport} folder and placed in {xmlimport}\XML-NOTOK. Specific errors are written to {xmlimport}\XML-NOTOK\{original filename}.error.

### Sample

The following illustrates a complete XML import file which contains one package. This format is compatible with Setup Center.

<?xml version=“1.0” encoding=“utf-8” ?>
<PackagingList>
<Packaging IdPackaging=“X0000013”
ComponentName=“IT/Component01”
ComponentBarcode=“Component01” OriginalQuantity=“100”
Quantity=“100”
Manufacturer=“Manufacturer01”ManufactureDate=“2004-01-
12T14:44:56+01:00”
ExpiryDate=“2010-12-31T14:44:56+01:00” Supplier=“Supplier01”
BatchId=“Batch01”
DeliveryNote=“Serial01” MsdLevel=“0” Extra1=“Extra01”
Extra2=“Extra02”
Extra3=“Extra03” Comment=“Dies ist ein Kommentar” />
Comment=“Dies ist ein Kommentar” />
</PackagingList>

### Station Interface

The purpose of the station interface is to notify the SIPLACE Station of component packaging locations, to block and open tracks, and to receive notifications from SIPLACE machines regarding used components and feeder positions.

### Coverage

Events

| Event Name | SIM Response |
|---|---|
| StationConnectionChanged | Logged |
| FillingLevelsChanged | Reel row updated |
| SetupControlDataReguest | Logged |
| NewSetupActive | Logged |
| FeederIdentButtonPressed | SIMA notified and track is selected |
| FeederPlaced | Feeder row added or updated |
| FeederRemoved | Feeder row disconnected from COT |

Station Methods

| Method | SIM Trigger |
|---|---|
| SetPackaging | Reel object added or updated |

### Inventory Items

### Feeders

Attributes

| Field | Description |
|---|---|
| strIdentifier | External identifier. |
| idFeederType | References feeder type table. |
| idChangeoverTable | Changeover table where the feeder resides or null if |
| | feeder is not on a table. |
| sTrack | Track where the feeder resides. This is irrelevant |
| | if not on a table. |
| strFullPath | Name of the feeder. |

### Rules

If a feeder is placed on a track on a table where another feeder currently exists, the existing feeder is automatically removed.

A feeder is automatically created if the SIM Assistant 12 attempts to add a reel to a track/table but a feeder does not exist at that location. This feeder is created of the type specified by the most recently downloaded setup or the selected offline setup.

A reel which is in the setup and marked as used, but is not present in inventory, will be considered unverified and will be blue.

A reel which is not the correct part number, or is on a feeder which has the incorrect dimensions, will be considered error and will be red.

A reel which exists in the setup but is marked as not used will be considered unused and will be white.

A reel which is at the correct place and is using a feeder of the correct dimensions but has not been scanned is considered to be matched and will be orange.

If any division on a feeder is in error, the feeder will be considered in error and will be red.

If any division on the feeder is unverified, the feeder will be unverified and will be blue. If all divisions of a feeder are empty, the feeder will be empty. If any division of the feeder is matched but not scanned, the feeder will be matched and will be orange.

Feeders are considered temporary if they are located in a folder named “Temporary Feeders”.

When feeders are removed from a table, the feeder and the divisions are deleted if the feeder is a temporary feeder.

### Feeder Divisions

Attributes

| Field | Description |
|---|---|
| idFeeder | Feeder on which the division resides. Never null. |
| idReel1 | Reference to the reel currently providing parts on the |
| | station. |
| idReel2 | Reference to the next reel which will provide parts |
| | (spliced reel). |
| idReel3 | Reference to the third reel which will provide parts |
| | (spliced). |
| nScanned | Indicates that the reel on this division has been |
| | scanned by SIM Assistant. |
| sReceptacle | Receptacle or division. |
| sLevel | Level used for tray feeders. |
| ucTower | Tower used for feeders. |

### Rules

A feeder division's nScanned attribute is marked as 1 (true) if any reel on that division has been scanned.

The nScanned attribute for all feeder divisions on a table is marked 0 (false) when a changeover table is connected to a station location.

Upon entering setup verification the first division, of the first feeder of the first table which is either error, unverified, or matched will be selected.

### Component Packaging

Attributes

| Field | Description |
|---|---|
| strFullPath | |
| strIdentifier | External identifier |
| oidPart | SIPLACE Pro OID of part. |
| iQuantity | |
| strManufacturer | |
| dtManufactured | |
| dtExpiration | |
| strSupplier | |
| strBatchId | |
| strSerial | |
| strUserBarcode1 | |
| strUserBarcode2 | |
| strUserBarcode3 | |
| iQuantityOriginal | |
| strMSDLevel | |
| iGreyZone | |

Rules

A temporary component packaging will be created if a user scans in an acceptable part barcode but does not scan in a reel identifier.

### Changeover Tables

Attributes

| Field | Description |
|---|---|
| idTableLocation | References StationLocation. |
| strFullPath | |
| strIdentifier | External identifier. |
| idTableType | References TableType. |

Rules

If any feeder on a table is in error, the table will be considered in error and will be red. If any feeder on the table is unverified, the table will be unverified and will be blue. If all feeders of a table are empty, the table will be empty. If any feeder of the table is matched but not scanned, the table will be matched and will be orange.

Any table in the “temporary tables” folder will be considered temporary.

### Table Locations

Table locations are used to represent each changeover table docking point on each station.

Attributes

| Field | Description |
|---|---|
| idStation | References Station |
| iLocation | Table location (1, 2, 3, 4) |
| strIdentifier | |

Rules

Temporary changeover tables are created and placed at each table location which does not have a COT in place at the start of any line view. The temporary tables will be created of the type required by the setup, or the type will be null if there are no reels required at a particular location.

A table of unknown type will be displayed as having 120 tracks.

The system 10 is an inventory control and setup verification system and provides for 1) inventory input, 2) set up verification, 3) material levels, 4) task optimization, and 5) traceability, as explained more fully below.

With regard to inventory input, the system 10 allows all reels being used in SMT production to be scanned into a database, prior to setup or even prior to entering the SMT area, e.g., in a receiving area. Once at the SMT area, the operator scans the reel here with the Assistant 12 for part number and quantity. The part number of the reel is verified from the database. The part number and quantity information is associated with the unique ID and is updated during production. Additional information such as vendor and lot code can also be scanned if required. Once the real is loaded on a machine and components are picked from it, the quantity on the reel is decremented in the database 18.

The use of unique identifications on the reels can facilitate capturing all the necessary component data (e.g., location and quantity) before the reels reach the shop floor. This ensures more accurate traceability. The component count is updated in the database during production for tracking purposes. Barcodes can be created directly with the system 10.

With regard to set up verification, the system 10 ensures that the correct materials are loaded onto the placement machine prior to production and during replenishment of individual material while production is running. The SIM Assistant 12 allows set ups to be verified offline on a mobile feeder table before product changeover. The user selects the offline set up function from the SIM Assistant display 24 and then selects the set up function that needs to be verified. Set ups are directly imported and automatically updated from the SIPLACE Pro database. The SIM Assistant 12 displays a view of the table with the status of each feeder on it. A color code is used where green indicates “verified”, red indicates “incorrect”, blue indicates “not verified” and white indicates “feeder not required”. The workflow for the operator is configurable for ease of use. Components can be scanned by track number. Alternatively, the user can scan the component part number first and the system will indicate which feeder and location to load the real onto. Once the table is verified, it can be docked into the machine during changeover. In addition, by scanning the table ID to the machine location ID, the system 10 can ensure that a verified table is ready to run.

With regard to material levels, the system 10 records and displays quantities and locations of all material consumed and all material still available for production in real time. The component level indicator is located on the graphical user interface (GUI) 30 of each machine 11 (FIG. 1). The operator is informed when they need to refill a certain track before it runs empty. Two levels can be programmed by the user: 1) when to set the warning and request a refill and 2) when to deactivate the track (before the tape disappears) enforcing a barcode scan and allowing still enough tape to splice (splicing is faster an inserting a new tape).

The SIM Assistant 12 shows the same information on a hit list (visually displayed list) as the hit list shown on each machine GUI 30. Thus, the order of components that need to be refilled by time or component level is shown. An advantage of the SIM Assistant 12 is that the component level hit list is visible to the operator wherever they may be. The component levels for one line or several lines can be compiled into one summary hit list on the SIM Assistant 12. The hit list guides the user to the next reel that needs to be replenished. This is determined by the component level on the reel and the BOM for the circuit board. Once a new reel has been spliced, the SIM Assistant 12 verifies that the correct components are used to replenish reels during production. The component level for that track is updated in the database 18.

With regard to tasks optimization, using the SIM assistant 12, the operator is guided to the next most important task. The system 10 indicates to the operator which tasks must be performed and at which location it must be done by a visual display (hit list). Workflow is thus configurable for optimal tasks efficiency. Thus, the SIM Service 14 monitors the component quantity levels on the machines 11 versus the component quantity needed for the product being produced and indicates to the user via the SIM Assistant 12 what components should be replenished first. If there is a machine error that stops the machine, the operator is notified via the Assistant 12 to attend to this error before doing anything else. A record is made as to how long the operator takes to fix the event. Via the system 10, the operator is informed as to whether there is enough material near the line to replenish components that are running out. Certain items on the line are moisture or temperature sensitive (e.g., environmentally sensitive) and need to be attended to in a timely manner. For example, solder paste needs to warm before use, so the operator can be informed when to take the solder paste out so there is enough time to warm.

With regard to traceability, all materials, including vendor-specific information, used in the manufacture of a unique PCB are recorded in a database for future reference.

As can be appreciated, with the system 10 real time syncing of multiple consoles and handhelds allows for multiple users to work on the same setup at the same time. With real time syncing, changes made on one computer or handheld (Assistant 12), will update all users as the change is being made, allowing for greater efficiency. The SIM Assistant 12 allows for factory workers to verify setups and check important issues from cordless barcode scanning computers. As factory workers update quantities and locations of inventory with the handhelds, instantaneous changes are made on the server allowing all users to see.

Graphic barcode definition allows for the user to visualize barcode formats and make changes as needed. The system 10 will also print new barcode labels as needed with unique IDs and updated quantities of components, for easy inventory updates when needed. By using barcodes affixed to the different inventory items SIPLACE requires a minimal amount of time to input new inventory, and recall items currently in inventory.

Thus, the system 10 keeps track of feeder status, keeps track of table location, keeps track of feeder location, keeps track of component inventory, enables barcode input of inventory, and warns of upcoming issues.

Although the invention has been described with regard to component placement machines, the invention is applicable to monitoring any machine process data of a PCB assembly line. For example, the invention is applicable to monitoring process data of screen printer (e.g., regarding stencil, solder paste, etc.) or to an oven (e.g., regarding the oven profile).

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A method of monitoring, in real time, process data of a printed circuit board assembly line, the method comprising:
monitoring one of status or data from machines in the assembly line,
based on the monitoring step, determining an order of events to be performed on the assembly line, with the determined order identifying a priority event, and
notifying a user of at least the priority event via at least one hand held device carried by the user, and
attending to the priority event on the assembly line.

2. The method of claim 1, wherein the machines are surface mount technology placement machines.

3. The method of claim 2, wherein the monitoring step includes monitoring component packaging data.

4. The method of claim 3, wherein the monitoring step includes polling .XML files that contain the component packaging data.

5. The method of claim 1, wherein the monitoring step includes receiving notifications from the machines regarding used components and component feeder positions.

6. The method of claim 1, wherein the monitoring step includes monitoring a component quantity levels on a machine and comparing the quantity levels to quantity levels needed to build a product produced by the machine.

7. The method of claim 6, wherein the notifying step includes notifying the user as to what components should be replenished first.

8. The method of claim 1, wherein the notifying step includes communicating the determined operation to the hand held device in a wireless manner.

9. The method of claim 8, wherein the hand held device has a display and the notifying step includes displaying information regarding the priority event.

10. The method of claim 1, wherein the notifying step includes notifying the user that an error has occurred on a machine.

11. The method of claim 1, wherein the notifying step includes notifying the user whether there is enough material near the assembly line to replenish components that are being consumed during assembly by a machine.

12. The method of claim 1, wherein the notifying step includes notifying the user of a time requirement regarding material that is environmentally sensitive.

13. The method of claim 1, wherein a plurality of hand held devices are provided.

14. The method of claim 1, wherein the machines are component placement machines and each machine has a graphical user interface showing information including the order of components that need to be refilled on the machine, and the method further includes displaying the information on the hand held device.

15. The method of claim 1, wherein the priority event is that a reel of components on a placement machine needs to be replenished and the attending step inclines splicing the reel to add further components.

16. A system for monitoring, in real time, machines of a printed circuit board assembly line, the system comprising:
a server having a processor configured for executing a monitoring process for monitoring one of status or data from machines in the assembly line, and based on the monitoring step, for determining an order of events to be performed on the assembly line, with the determined order identifying a priority event, and
a hand held device in communication with the server, the hand held device being constructed and arranged to be carried by a user at the assembly line, the hand held device having a display configured for displaying at least the priority event to the user.

17. The system of claim 16, wherein the server and the hand held device are constructed and arranged to communicate in a wireless manner.

18. The system of claim 16, wherein the hand held device is a PDA having a touch screen display, a keyboard and a bar code scanner.

19. The system of claim 16, further comprising at least one console remote from the server and in communication therewith, each console having a keyboard and a display.

20. The system of claim 19, wherein the processor is configured for analyzing allocation data of a placement machines and the server is configured for communicating the allocation data to the console so that a user of the console can view where component packaging items, tables, and feeders are currently allocated.
